(19) United States
(12) Patent Application Publication
(10) Pub. No.: US 2026/0319848 A1
(43) Pub. Date: Oct. 15, 2026

(54) RESOURCE ADAPTION FOR DISTRIBUTED COMPUTING ENVIRONMENTS

(71) Applicant: Hewlett Packard Enterprise Development LP, Spring, TX (US)

(72) Inventors: Siva Prasad Chowdary Erigineni, Pleasanton, CA (US); Krishna Rao Mosalakanti, Cupertino, CA (US); Dheeraj Parchuru, Fremont, CA (US)

(21) Appl. No.: 19/177,870

(22) Filed: Apr. 14, 2025

(51) Int. Cl. G06F 9/50

(52) U.S. Cl. CPC G06F 9/5027

(57) ABSTRACT

Monitoring data for a distributed computing environment is collected, where the distributed computing environment comprises multiple compute nodes running software services. The monitoring data includes node-level resource usage data collected using resource collection agents running in the compute nodes. Service-level resource consumption profiles for the software services are calculated based on the node-level resource usage data. The distributed computing environment is then updated based on the service-level resource consumption profiles.

### BACKGROUND

In modern computing environments, distributed systems have become increasingly prevalent. These systems consist of multiple interconnected computers or nodes that work together to perform tasks and process data. By distributing workloads across multiple machines, organizations can achieve greater scalability, reliability, and performance compared to traditional single-server architectures.

One common approach to managing distributed systems is through the use of computing clusters. A cluster is a group of computers that are linked together and operate as a single system. This arrangement allows for efficient resource allocation and workload distribution across the constituent nodes. Clusters can be configured for various purposes, such as high-availability systems, load balancing, or parallel processing of complex computations.

As distributed systems and clusters have grown in complexity, new tools and technologies have emerged to simplify their management and operation. These include container orchestration platforms, which automate the deployment, scaling, and management of containerized applications across a cluster of nodes. One example of such a platform is Kubernetes, which has gained widespread adoption in recent years.

The rise of cloud computing has further accelerated the adoption of distributed systems and cluster-based architectures. Cloud platforms provide on-demand access to vast pools of computing resources, enabling organizations to rapidly scale their infrastructure up or down based on changing needs. This flexibility has made it easier for organizations to leverage the power of distributed computing without the upfront costs and complexity of maintaining physical hardware.

### BRIEF DESCRIPTION OF THE DRAWINGS

For a more complete understanding of this disclosure, and advantages thereof, reference is now made to the following descriptions taken in conjunction with the accompanying drawings.

FIG. 1 illustrates a block diagram of a computing system, according to some implementations.

FIG. 2 illustrates a block diagram of a distributed computing environment, according to some implementations.

FIG. 3 illustrates a block diagram of the software architecture of a distributed computing environment, according to some implementations.

FIG. 4 illustrates a block diagram of the software architecture of a distributed computing environment, according to some implementations.

FIG. 5 illustrates a flowchart of a method for adapting resource consumption in a distributed computing environment, according to some implementations.

Corresponding numerals and symbols in the different figures generally refer to corresponding parts unless otherwise indicated.

### DESCRIPTION

The following disclosure provides many different examples for implementing different features. Specific examples of components and arrangements are described below to simplify the present disclosure. These are, of course, merely examples and are not intended to be limiting.

Efficiently managing resource consumption in distributed computing environments is challenging, particularly in the context of computing clusters. In such environments, a distributed computing system includes multiple nodes, which may be physical machines or virtual machines that form a computing cluster. These nodes run various software services, typically packaged as containers, which may be orchestrated and managed by a control plane. As organizations increasingly rely on cloud-based services and containerized applications, the complexity of managing resources across multiple compute nodes and software services has considerably grown. Traditional approaches to resource allocation in computing clusters often result in over-provisioning or under-utilization of node resources, leading to inefficient use of resources and increased operational costs. Furthermore, the dynamic nature of modern applications and varying workloads makes it difficult to maintain suitable resource allocation over time.

This disclosure describes systems and methods for adapting resource consumption in distributed computing environments (specifically, computing clusters) through intelligent monitoring, analysis, and dynamic adjustment of computing resources. The approach involves collecting detailed resource usage data at the node level of a computing cluster, analyzing this data to create service-level resource consumption profiles, and using these profiles to make informed decisions about resource allocation and service configuration in a distributed computing environment.

In some cases, a distributed computing environment may be established comprising multiple compute nodes, each running various software services. A resource collection agent may be deployed on each compute node to gather node-level resource usage data for the services running on the respective node. This data may include a wide range of metrics such as per-container CPU utilization, memory usage, I/O operations, network bandwidth consumption, network latency, inter-container communication metrics, system call patterns, programming language-specific metrics, and database query patterns. By collecting such comprehensive data about services at the node level, a detailed picture of resource consumption across the entire distributed environment may be formed.

The collected node-level resource usage data may then be used to calculate service-level resource consumption profiles for the software services running in the distributed computing environment. This process may involve normalizing and aggregating the node-level data to create a holistic view of how each service consumes resources across the environment. These profiles may provide insights into the resource consumption patterns of individual services, allowing for more informed decision-making regarding resource allocation. Additionally, these patterns may be analyzed to identify impacted services that exhibit disproportionate or excessive resource consumption relative to other services or expected baselines.

Based on the service-level resource consumption profiles, the distributed computing environment may be updated to improve overall efficiency and performance. This updating process may take various forms depending on the specific insights gained from the resource consumption profiles and the nature of the identified resource consumption issues. In some cases, the update may involve changing the computing resource allocation to an impacted service that has been identified as resource-constrained. In some cases, the scale level of an impacted service may be adjusted, either increasing or decreasing the number of instances to better match the observed resource consumption patterns of the service. In some cases, the update may involve deploying changes to the source code of an impacted service, addressing inefficiencies or improving resource usage at the application level to mitigate excessive resource consumption.

The described approach offers several advantages over traditional resource management techniques. Monitoring and analyzing resource consumption of individual services in a computing cluster may enable more precise and dynamic resource allocation. This may lead to improved overall efficiency of the distributed computing environment, reducing waste and improving resource utilization. Furthermore, the ability to identify and address resource consumption issues of individual services allows for targeted adaptions, potentially improving application performance and reducing operational costs. The system’s capability to adapt to changing workloads and resource demands also enhances the scalability and flexibility of the distributed computing environment, enabling organizations to more effectively manage their computing resources in the face of evolving requirements and technologies.

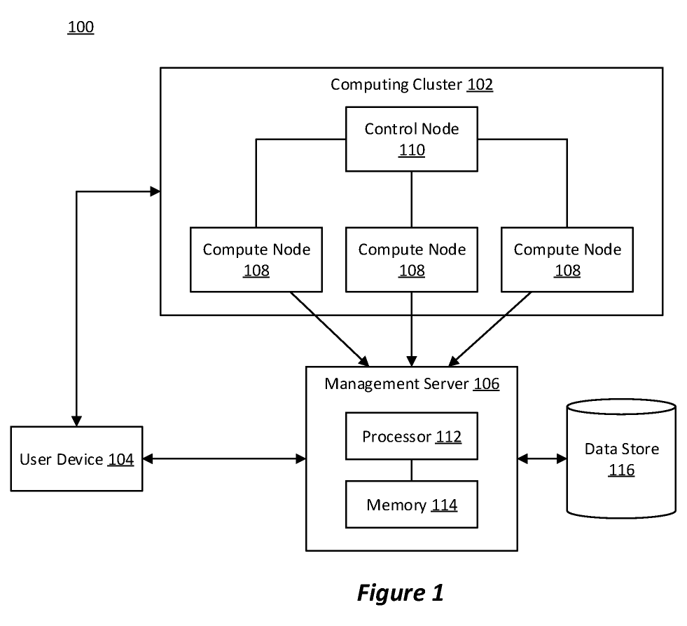

FIG. 1 illustrates a block diagram of a computing system 100, according to some implementations. The computing system 100 includes a computing cluster 102, a user device 104, a management server 106. These components work together to provide a distributed computing environment that may be monitored and adapted for efficient resource utilization.

The computing cluster 102 may be part of a distributed computing environment designed to manage and execute various workloads across multiple interconnected nodes. This cluster architecture enables organizations to harness the collective power of multiple machines, enhancing scalability, reliability, and performance for complex computational tasks. The computing cluster 102 comprises multiple compute nodes 108 and a control node 110. These nodes may be implemented as physical hardware servers or virtual machines. The control node 110 serves as the central management point for the computing cluster 102, coordinating activities, scheduling tasks to the compute nodes 108, and maintaining the overall health and configuration of the environment.

The compute nodes 108 execute actual computational tasks and run software services. These nodes may host containerized applications, microservices, or other types of software components that perform desired functions within the distributed system. The compute nodes 108 may include processors, memories, network interfaces, I/O features, and the like which are utilized by the software running on the compute nodes 108. The compute nodes 108 communicate with each other and the control node 110 to share data, balance workloads, and ensure efficient resource utilization across the cluster. The services running on the compute nodes 108 may interact with each other and work together to provide a desired functionality to a user device 104.

The software services running on the compute nodes 108 may vary widely in their purpose and resource requirements. These services may include web applications, databases, data processing pipelines, machine learning models, or any other type of computational workload. To improve performance and resource allocation, the computing cluster 102 may employ mechanisms to collect detailed node-level resource usage data for these software services. As subsequently described in greater detail, this usage data may be used to calculate resource consumption profiles for the services running on the compute nodes 108, and the computing system 100 may be updated based on the resource consumption profiles of the services.

In one example implementation, the computing cluster 102 may be a Kubernetes cluster, where the software services run on pods that are deployed to the compute nodes 108 by the control node 110, leveraging Kubernetes’ container orchestration capabilities.

The user device 104 may be operated by an end-user or an administrator. When operated by an end-user, the user device 104 may run an end-user client, such as an application, that accesses functionality provided by the computing cluster 102. When operated by an administrator, the user device 104 may run a management client, such as an administrative dashboard or monitoring interface, that enables users to configure and monitor the management server 106. The user device 104 may be any type of computing device, such as a desktop computer, laptop, smartphone, tablet, or Internet of Things (IoT) device. These devices can connect to the computing cluster 102 and/or the management server 106 through various network protocols, such as HTTP, HTTPS, WebSocket, proprietary application programming interfaces (APIs), or the like.

The management server 106 may perform resource adaption within the computing system 100. It monitors resource utilization patterns across the compute nodes 108 in the computing cluster 102, collecting telemetry data that provides visibility into how software services consume computing resources. Based on this monitoring, the management server 106 analyzes the collected information to identify inefficiencies, bottlenecks, or opportunities for improvement in the computing cluster 102. It then updates the distributed computing environment by implementing changes such as adjusting resource allocations, scaling services, or performing code-level modifications to address identified resource consumption issues. This continuous monitoring and adaption process helps maintain performance of the computing cluster 102 while reducing resource waste across the computing cluster 102.

To accomplish its resource adaption, the management server 106 collects monitoring data from the compute nodes 108 and control node 110, including metrics such as CPU utilization, memory usage, network traffic, and application-specific performance indicators. This monitoring data may include node-level information collected by resource collection agents running on the compute nodes 108. These agents may gather detailed metrics about the performance and resource consumption of individual software services operating on each compute node 108. This data is analyzed to create detailed resource consumption profiles for each software service in the computing cluster 102, revealing patterns of resource utilization over time and enabling identification of inefficiencies on a service-level basis. The management server 106 then implements targeted updates to the distributed computing environment based on these profiles, such as adjusting resource allocations, dynamically scaling services, or performing code-level modifications for the services. Additionally, the management server 106 may employ predictive analytics to anticipate future resource requirements, allowing for proactive configuration adjustments that maintain acceptable performance while reducing operational costs.

Examining service-level resource consumption may provide more granular and actionable insights compared to estimating overall resource consumption for an application provided by the computing cluster 102. By analyzing individual services, the system can identify specific services (of an application) that may be underperforming or consuming disproportionate resources within the computing cluster 102. This detailed view allows for targeted environment updates, such as fine-tuning resource allocations, scaling specific services, or addressing code-level inefficiencies. In contrast, overall application estimates may obscure bottlenecks or inefficiencies within particular services, potentially leading to poor resource allocation decisions. Service-level analysis may also enable more accurate capacity planning and cost attribution, as resource usage can be mapped directly to specific services of an application. This approach may ultimately result in more efficient resource utilization, improved application performance, and reduced operational costs across the distributed computing environment.

The management server 106 may include suitable components for performing any desired functionality. One or more modules within the management server 106 may be partially or wholly embodied as software and/or hardware for performing any functionality described herein. For example, the management server 106 may include a processor 112 and a memory 114. The processor 112 may be a microprocessor, an application-specific integrated circuit, a microcontroller, or the like. The memory 114 may be a non-transitory computer-readable medium that stores instructions for execution by the processor 112. The instructions, when executed by the processor 112, may cause the processor 112 to perform any functionality described herein.

The computing system 100 may also include a data store 116. The data store 116 may provide storage capacity for the monitoring data from the computing cluster 102 as well as the calculated resource consumption profiles of the services within the computing cluster 102. The data store 116 may be implemented using various storage technologies, such as relational databases, NoSQL data stores, distributed file systems, object storage, block storage, or the like depending on the specific requirements of the computing system 100.

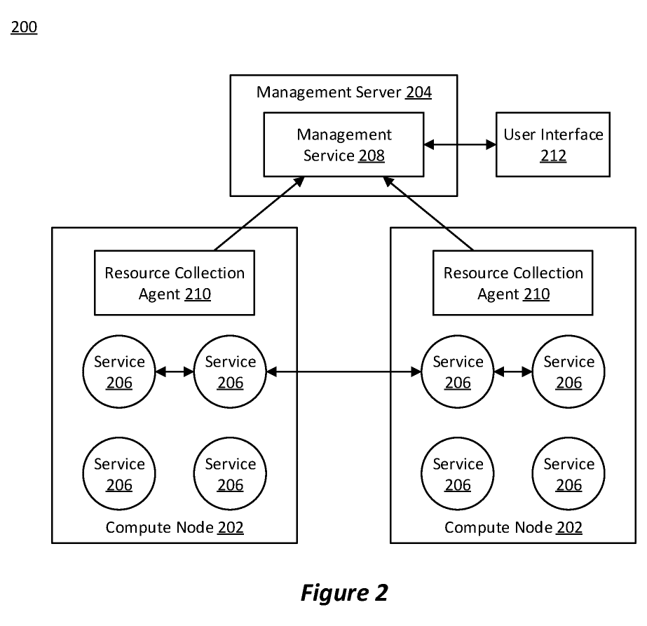

FIG. 2 illustrates a block diagram of a distributed computing environment 200, according to some implementations. The distributed computing environment 200 includes multiple compute nodes 202 and a management server 204. These components may correspond to the components of the computing system 100 described in FIG. 1.

The compute nodes 202 may form a computing cluster within the distributed computing environment 200. Each compute node 202 may host and run one or more software services 206. The compute nodes 202 may communicate with each other and with the management server 204 to share data, balance workloads, and coordinate resource utilization across the distributed computing environment 200.

The management server 204 may be responsible for collecting monitoring data from the compute nodes 202 and coordinating resource utilization across the distributed computing environment 200. The management server 204 may run a management service 208 that receives monitoring data from resource collection agents 210 running on each of the compute nodes 202.

The software services 206 are the core functional components that run on the compute nodes 202. For example, the software services 206 may include infrastructure services and application services. An infrastructure service may include a database service, monitoring service, hardware control service, application-related service, etc. An application service may be a discrete unit of functionality (e.g., microservice) that performs specific tasks or operations for an application within the distributed computing environment 200. These software services 206 may interact with each other and with other components of the distributed computing environment 200 to provide the overall functionality of the system. In some cases, the software services 206 may be implemented as containerized applications deployed to the compute nodes 202. Containerization allows for consistent deployment and execution of the software services 206 across different compute nodes 202, so that each service has access to the necessary dependencies and resources while maintaining isolation from other services running on the same compute node 202. The software services 206 running on the compute nodes 202 may engage in various types of interactions within the distributed computing environment 200. These interactions may include inter-node interactions, where software services 206 across compute nodes 202 exchange data or coordinate activities, as well as intra-node interactions, where software services 206 within a single compute node 202 work together to perform a specific function.

The resource collection agents 210 run on the compute nodes 202. For example, they may be containerized applications running on the compute nodes 202 or may be agents running directly on the operating systems of the compute nodes 202. These agents collect detailed telemetry data about resource utilization of the software services 206 operating on the compute nodes 202. The resource collection agents 210 may leverage kernel-level monitoring capabilities, container runtime APIs, system monitoring libraries, or the like to gather comprehensive metrics about the software services 206. These metrics are then transmitted to the management service 208 for aggregation and analysis, enabling service-level resource consumption profiling across the distributed computing environment 200.

The resource collection agents 210 running on the compute nodes 202 operate at the node level to collect comprehensive node-level resource usage data for the software services 206 executing on that particular node. The resource collection agents 210 can capture fine-grained, low-level data about the resource consumption patterns of individual software services 206 within the compute nodes 202, providing detailed insights into their performance and resource utilization.

The node-level resource usage data (collected by the resource collection agents 210) encompasses a wide range of metrics that provide insights into the performance and resource utilization of the software services 206. This data may include per-container CPU utilization, offering a granular view of how each software service 206 consumes processing resources. Memory usage metrics may also be captured, allowing for analysis of memory consumption patterns across different services, including details on resident set size (RSS) versus virtual set size (VSS), and potentially including details on memory leaks. The resource collection agents 210 may also gather data on I/O operations, including disk access patterns, providing visibility into how the software services 206 interact with storage systems and other I/O-dependent resources.

Network bandwidth consumption metrics may also be collected to understand the communication patterns and data transfer requirements of various software services 206. This may include detailed breakdowns of external calls to databases and cache accesses, as well as information on the protocols used by the software services 206, such as TCP, UDP, HTTP/HTTPS/HTTP2, and the like. The resource collection agents 210 may inspect packets at the transport layer, capturing details on maximum segment size (MSS) and sliding window changes to understand the nature of connections used to communicate with various sources.

In addition to these fundamental resource metrics, the resource collection agents 210 may capture more specialized data points that offer deeper insights into service behavior and performance. For example, the resource collection agents 210 may collect inter-container communication metrics, which can reveal patterns of interaction between different components of distributed applications. System call patterns may be monitored, providing low-level information about how software services 206 interact with the underlying operating system, including details on native OS-level threads used.

The resource collection agents 210 may also gather data on database query patterns, offering visibility into how services interact with databases and potentially identifying inefficient query structures or excessive database operations. This may include tracking the duration of infrastructure queries, the amount of data input/output between the infrastructure and specific applications, round-trip times, long-lived sessions, the number of sessions each application container is holding, transaction times, and the like.

In some cases, the resource collection agents 210 may gather information about the programming languages used by the software services 206. This may include identifying whether a particular service is implemented in Java, Python, Go, C++, Rust, or another language. Such information can be valuable for understanding resource consumption patterns, as the choice of programming language may impact factors like memory usage, CPU utilization, and overall performance. For instance, the resource collection agents 210 may capture insights into Java virtual memory usage or identify compute-intensive patterns in Python applications using packages like Celery.

Furthermore, the node-level resource usage data may include details about the packages and libraries utilized by the software services 206. This may encompass information about third-party dependencies, frameworks, and runtime environments employed by each software service 206. Understanding the specific packages and libraries used by the software services 206 may provide insights into potential resource bottlenecks or optimization opportunities, as certain libraries or packages may have known performance characteristics or resource requirements that could impact the overall efficiency of the distributed computing environment 200.

The resource collection agents 210 may also identify the hardware being used by the software services 206, including any hardware accelerators for operations like encryption or decryption. This hardware identification capability enables the resource collection agents 210 to determine whether applications are utilizing specialized hardware resources efficiently.

The resource collection agents 210 may also identify network devices being used by the applications or containers. The resource collection agents 210 may identify workloads in terms of the number of devices supported by each software service 206, such as access points, switches, or gateways. This provides visibility into how services interact with and manage network infrastructure components.

To collect this comprehensive node-level resource usage data, the resource collection agents 210 may leverage advanced monitoring technologies such as extended Berkeley Packet Filtering (eBPF). eBPF allows for efficient, low-overhead monitoring of system events and resource usage, enabling the resource collection agents 210 to gather detailed metrics without significantly impacting the performance of the software services 206 being monitored. By utilizing eBPF, the resource collection agents 210 can capture a wide range of system events and resource utilization data at the compute nodes 202, providing a comprehensive view of how software services 206 consume resources within the distributed computing environment 200.

The resource collection agents 210 gather the aforementioned node-level resource usage data, normalize this information, and transmit it to the management service 208 on the management server 204. This normalized data may have a consistent format that can be effectively compared across different compute nodes 202 and software services 206. Upon receiving the monitoring data from the resource collection agents 210, the management service 208 performs further aggregation and analysis, employing various data processing techniques to derive meaningful insights from the collected information.

The management service 208 receives and processes resource usage data from the resource collection agents 210. By analyzing this data, the management service 208 develops a detailed understanding of how each software service 206 consumes resources within the distributed computing environment 200. This analysis informs decisions about resource allocation, service scaling, and other changes to improve the overall efficiency and performance of the distributed computing environment 200. Based on this analysis, updates to the distributed computing environment 200 may be implemented.

Using the collected monitoring data, the management service 208 calculates detailed resource usage profiles for each software service 206 operating within the distributed computing environment 200. These profiles may incorporate historical usage patterns, current resource consumption trends, and other relevant metrics to provide a comprehensive view of how each software service 206 utilizes resources, including over time. The resource usage profiles may take into account various factors such as CPU utilization patterns, memory consumption trends, I/O operation frequencies, network bandwidth usage, database query patterns, and additional metrics collected by the resource collection agents 210. These may include per-container resource attributes, programming languages of the software services 206, packages used, native threads, device load, network access breakdown, system calls, memory access patterns, hardware usage, and the like.

The management service 208 executes a series of analytical steps to process the data into resource usage profiles. The management service 208 breaks down resource usage by individual services and characterizes them based on their access patterns to resources such as queues, databases, object storage, and external caches. The management service 208 may use supervised linear or logistic regression to predict future costs for new services. Additionally, the management service 208 may employ Principal Component Analysis (PCA) to identify independent costing factors for the various parameters collected, allowing for a more nuanced understanding of resource consumption drivers.

The management service 208 may rank applications by normalizing their resource consumption attributes based on a configurable cost hierarchy. This hierarchy may prioritize certain resource types over others, allowing for customized resource adaption strategies. For example, the system may be configured to rank network access costs higher than memory costs, or I/O costs higher than compute costs, depending on the specific needs and constraints of the distributed computing environment 200.

By analyzing these resource usage profiles, the management service 208 can identify potential inefficiencies, resource bottlenecks, or opportunities for adaption within the distributed computing environment 200. For example, the management service 208 may detect software services 206 that consistently consume a disproportionate amount of CPU resources, identify patterns of inefficient memory usage that could be addressed through code modifications, or reveal opportunities to improve service interactions and database access patterns.

The management service 208 may identify applications that exhibit efficient resource utilization patterns, sometimes referred to as environmentally conscious or “green” applications, and propose strategies to further reduce their resource consumption. These applications typically operate with lower CPU usage, memory consumption, and I/O operations compared to similar services. The management service 208 may suggest dynamic resource allocation techniques, such as automatically scaling down allocated resources during off-peak hours or periods of low demand, implementing more aggressive power management strategies, or recommending code-level changes to improve energy efficiency. In some implementations, the management service 208 may focus on “greenifying” specific types of applications, such as Monitoring and Real-Time (MRT) services, configuration management services, and infrastructure helper applications. For these application categories, the management service 208 may apply tailored update strategies that consider their unique operational characteristics and resource requirements. For example, MRT services may benefit from more efficient data sampling and aggregation techniques, while configuration management services could be optimized for reduced database access and improved caching strategies.

The management service 208 employs various clustering algorithms to group software services 206 with similar usage patterns. These may include k-Nearest Neighbors (kNN) for grouping services with similar costing profiles, K-means or Birch for more fine-grained analysis, Centroid clustering to determine mean usage for various costing categories, DBSCAN or OPTICS to identify outliers in terms of resource consumption, or the like. These clustering techniques help in categorizing software services 206 and identifying those that may benefit from optimization. By grouping the software services 206 into resource consumption groups based on their usage patterns, the management service 208 can more effectively identify impacted services that exhibit anomalous behavior compared to other services within the same group. For example, if most monitoring services in a cluster use a consistent amount of memory and network resources, but one particular monitoring service consumes significantly more resources than others in its group, it may be identified as an impacted service requiring attention. This grouping approach enables the management service 208 to establish baseline expectations for different types of services and detect deviations that might indicate inefficiencies, bugs, or opportunities for optimization, ultimately leading to more targeted and effective resource management strategies.

The management service 208 may also analyze the sensitivity of software services 206 to restarts and connectivity breakdowns with dependent infrastructure. This analysis may involve monitoring how quickly services recover from restarts, the impact of temporary network disruptions on service performance, and the cascading effects of infrastructure failures on interconnected services. By understanding these sensitivities, the management service 208 can recommend strategies to improve service resilience, such as implementing circuit breakers, retries with exponential backoff, or more robust error handling mechanisms.

Furthermore, the management service 208 may perform detailed logging and trace analysis to gain deeper insights into the behavior and performance of the software services 206. This may include analyzing log patterns to identify recurring issues, correlating logs across multiple services to debug complex interactions, and using distributed tracing to understand the flow of requests through the system. The trace analysis can help identify performance bottlenecks, latency issues, and inefficient communication patterns between services, enabling more targeted adaptions and improvements to the overall system architecture.

Based on the insights the management service 208 calculates using the monitoring data, the management service 208 may implement data-driven updates to the distributed computing environment 200. It may dynamically adjust resource allocations to software services 206 identified as resource-constrained or inefficient. The management service 208 may also modify the scale level of certain software services 206 by increasing or decreasing the number of instances based on observed usage patterns and predicted future requirements. For services with persistent performance issues, the management service 208 may coordinate code-level changes by deploying updated versions of the software services 206 with improved resource efficiency.

Additionally, the management service 208 may reconfigure the placement of software services 206 across compute nodes 202, such as by moving containers, to balance workloads and reduce resource contention. It may also provide insights into the impact of technology choices on application performance and cost. The management service 208 may identify how different choices affect the software services 206 in terms of resource consumption and costs. For example, the management service 208 may analyze and compare the efficiency of services written in different programming languages (e.g., Python vs. Go), using different database systems (e.g., ArangoDB vs. ClickHouse, PostgreSQL vs. MySQL, etc.), or employing different API architectures (e.g., GraphQL vs. REST API). This analysis can help inform technology stack decisions to improve resource utilization and cost-efficiency.

The management service 208 can identify patterns in resource usage fluctuations, enabling proactive resource allocation strategies. By analyzing historical data and recognizing recurring patterns, the management service 208 can anticipate periods of increased demand and adjust resource allocations accordingly. For example, in an enterprise setting, the management service 208 might detect that network usage and computational demands spike during scheduled conferences or organization-wide events.

The management service 208 may also include capabilities for analyzing and improving power consumption across the distributed computing environment 200. By correlating resource usage data with power consumption metrics, the system can identify opportunities for reducing energy usage and improving overall efficiency. This may involve recommending hardware upgrades, adjusting cooling systems, or implementing more aggressive power management policies for underutilized resources.

In some implementations, the management service 208 may automatically generate and raise bug tickets for inefficient resource usage patterns, allowing development teams to address these issues. The management service 208 may integrate with version control systems to suggest code changes that could improve resource efficiency. This integration may allow the system to automatically create pull requests or merge requests with suggested changes to the software services 206, streamlining the process of implementing efficiency improvements. Through these comprehensive analyses and automated actions, the management service 208 continually works to improve the performance and resource efficiency of the distributed computing environment 200.

By leveraging the detailed insights provided by these resource usage profiles, the management service 208 can develop a nuanced understanding of how different software services 206 consume resources, allowing for more targeted and effective resource management strategies. This approach enables data-driven decision-making about resource allocation, service scaling, and other changes within the distributed computing environment 200, potentially leading to significant performance improvements and resource savings.

The distributed computing environment 200 may include a user interface 212 that provides users with access to the management service 208. Through the user interface 212, users may interact with and view information about the distributed computing environment 200, including detailed resource usage data for the software services 206. This granular view may enable users to gain insights into resource consumption patterns and identify potential areas for optimization within the distributed computing environment 200. In some cases, the user interface 212 may be implemented as a graphical user interface, presenting service resource usage information through visual representations such as charts, graphs, and tables. In other cases, the user interface 212 may be implemented as a text-based interface, allowing users to input commands and queries to retrieve specific information about resource usage in the distributed computing environment 200.

The management server 204 may include a language model service that supports natural language queries from users through the user interface 212. This language model service may leverage natural language processing techniques to interpret user queries and provide relevant information about resource usage in the distributed computing environment 200. For example, a user may input a query such as “Show me the software services with the highest CPU usage in the last 24 hours,” and the language model service may interpret this query, retrieve the appropriate data from the management service 208, and present the results through the user interface 212. The language model service may be based on a custom Large Language Model (LLM) trained on environment-specific data, including historical logs, application performance data, and domain-specific terminology. This custom LLM enables more accurate and context-aware responses to user queries, taking into account the unique characteristics of the distributed computing environment 200.

The user interface 212 may also provide mechanisms for users to interact with the management service 208 and initiate actions based on the resource usage information presented. For example, users may be able to adjust resource allocations to software services 206, scale software services 206, or trigger optimization processes directly through the user interface 212. These interactions may be subject to appropriate access controls and permissions so that only authorized users can make changes to the distributed computing environment 200.

The management server 204 may also include a programming interface (not separately illustrated) that, like the user interface 212, provides access to the management service 208. For example, the management server 204 may provide an API for software to programmatically interact with and control the management service 208.

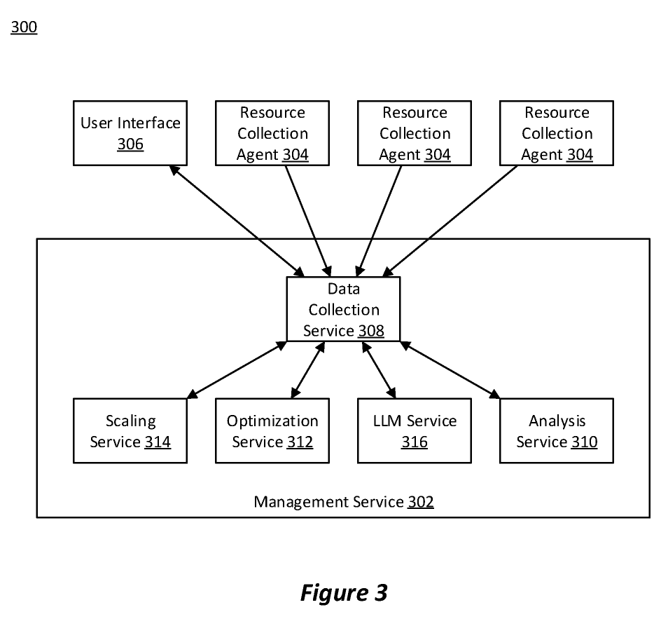

FIG. 3 illustrates a block diagram of the software architecture of a distributed computing environment 300, according to some implementations. The architecture is an example of various software components that may be used to implement, e.g., the distributed computing environment 200 of FIG. 2. The distributed computing environment 300 includes a management service 302, multiple resource collection agents 304, and a user interface 306. These components may correspond to the components of the distributed computing environment 200 described in FIG. 2.

The management service 302 may collect and analyze data from the resource collection agents 304 running on compute nodes, process user inputs from the user interface 306, and implement updates to the distributed computing environment 300 based on the analyzed data and user inputs. The management service 302 may be implemented with multiple services. In some implementations, the management service 302 includes a data collection service 308, an analysis service 310, an optimization service 312, a scaling service 314, and a language model service 316.

The data collection service 308 receives and processes monitoring data from the resource collection agents 304, aggregating and normalizing the data for further analysis. The data will be used to calculate resource consumption profiles for software services based on the collected data. In some cases, the data collection service 308 may employ various data processing techniques to clean and standardize the incoming data from multiple resource collection agents 304, ensuring consistency across different compute nodes. The data collection service 308 may aggregate the data over specified time intervals, creating time-series representations of resource usage patterns for each software service. Additionally, the data collection service 308 may apply normalization techniques to account for differences in hardware capabilities or configurations across compute nodes, allowing for more accurate comparisons between software services running on different infrastructure.

The analysis service 310 performs detailed analysis of resource consumption patterns, creating service-level resource consumption profiles that may be used to identify potential inefficiencies or bottlenecks in the distributed computing environment 300. The analysis service 310 may employ various statistical and machine learning techniques to extract meaningful insights from the processed data. In some cases, the analysis service 310 may use time-series analysis to identify trends and seasonality in resource usage patterns. The analysis service 310 may also perform correlation analysis to understand relationships between different resource metrics and their impact on overall service performance. By analyzing these patterns, the analysis service 310 may identify software services that consistently consume disproportionate amounts of resources or exhibit unexpected spikes in resource usage. The analysis service 310 may also compare resource consumption profiles across similar software services to benchmark performance and identify opportunities for improvement.

The optimization service 312 identifies opportunities for resource adaption and implements updates to the software services. Based on the insights provided by the analysis service 310, the optimization service 312 may develop and execute strategies to improve resource utilization across the distributed computing environment 300. In some cases, the optimization service 312 may recommend adjustments to resource allocations, such as increasing or decreasing CPU or memory limits for specific software services. The optimization service 312 may also suggest changes to service configurations, such as modifying database query patterns or network communication protocol usage. Additionally, the optimization service 312 may generate code change recommendations to optimize software services. These recommendations may include suggestions for more efficient algorithms, improved data structures, better resource management practices, or the like. In some implementations, the optimization service 312 may integrate with version control systems to automatically submit code changes, streamlining the update process and reducing the manual effort required from development teams.

The scaling service 314 manages the dynamic scaling of software services based on resource consumption patterns identified in the monitoring data. The scaling service 314 may use predictive models to anticipate future resource requirements and proactively adjust the scale of software services. In some cases, the scaling service 314 may implement auto-scaling policies that automatically increase or decrease the number of instances of a software service based on predefined metrics or thresholds. The scaling service 314 may also consider factors such as time of day, historical usage patterns, and scheduled events when making scaling decisions. In some cases, the scaling service 314 may implement manual scaling policies that, in combination with the aforementioned factors, also consider user input (e.g., configuration parameters) when making decisions to increase or decrease the number of instances of a software service. By dynamically adjusting the scale of software services, the scaling service 314 helps ensure that the distributed computing environment 300 can efficiently handle varying workloads while minimizing resource waste.

The language model service 316 processes natural language queries from users through the user interface 306. The language model service 316 may employ natural language processing techniques to interpret user queries and provide relevant information about resource usage and performance in the distributed computing environment 300. In some cases, the language model service 316 may use machine learning models trained on domain-specific data to understand and respond to complex queries about resource utilization, service performance, and optimization opportunities. The language model service 316 may also generate human-readable summaries of resource consumption patterns and update recommendations, making the insights from the analysis service 310 and optimization service 312 more accessible to users with varying levels of technical expertise.

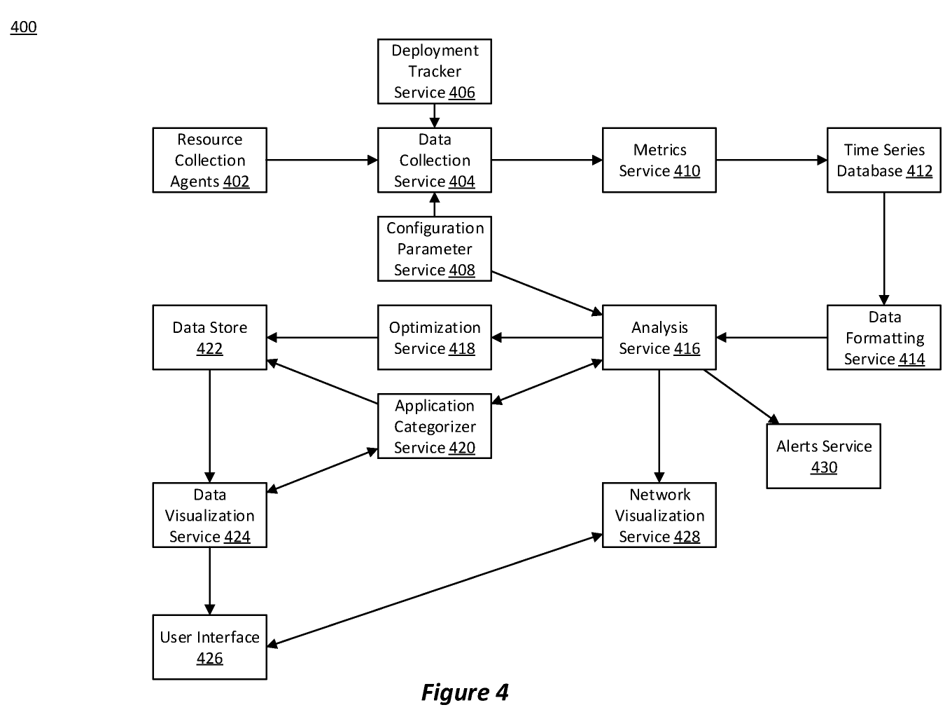

FIG. 4 illustrates a block diagram of the software architecture of a distributed computing environment 400, according to some implementations. The architecture is also an example of various software components that may be used to implement, e.g., the distributed computing environment 200 of FIG. 2. In particular, FIG. 4 shows additional details which may be used to implement the components in FIGS. 2-3. The distributed computing environment 400 comprises multiple interconnected components that work together to collect, analyze, and visualize data related to resource usage and performance of software services running on compute nodes within the distributed computing environment 400, and update the distributed computing environment 400 to improve resource utilization. Some of these components may correspond to the components of the distributed computing environment 300 described in FIG. 3.

Resource collection agents 402 are deployed on each compute node within the distributed computing environment 400. These resource collection agents 402 are responsible for collecting comprehensive node-level resource usage data for the software services running on their respective compute nodes. The resource collection agents 402 may use extended Berkeley Packet Filtering (eBPF) to efficiently gather low-level system data without significantly impacting the performance of the monitored software services. The node-level resource usage data collected by the resource collection agents 402 may include per-container CPU utilization, memory usage, I/O operations, network bandwidth consumption, network latency, inter-container communication metrics, system call patterns, programming language-specific metrics, and database query patterns. In some cases, the resource collection agents 402 may also collect data on hardware accelerator usage by services, as well as information about the programming languages and specific software packages and frameworks used by the services.

A data collection service 404 receives the node-level resource usage data from the resource collection agents 402. The data collection service 404 may aggregate this data. In some implementations, the data collection service 404 may normalize this data to create a consistent format for further analysis. In addition to the data from the resource collection agents 402, the data collection service 404 may also receive input from a deployment tracker service 406. The deployment tracker service 406 may monitor changes in the deployment of software services within the distributed computing environment 400, providing context for changes in resource usage patterns that may be related to service updates or reconfigurations.

A configuration parameter service 408 may also interface with the data collection service 404, providing configuration settings that may influence how the collected data is processed and analyzed. These configuration parameters may include thresholds for resource usage alerts, definitions of resource consumption hierarchies, settings for service scaling, or settings for data aggregation and normalization processes. The interaction between the configuration parameter service 408 and the data collection service 404 may be governed by role-based access control (RBAC), so that only authorized users with appropriate permissions can modify configuration settings. By adjusting these parameters, the system may be fine-tuned to focus on specific aspects of resource usage or to adapt to changing priorities in resource management.

A metrics service 410 receives the processed data from the data collection service 404. The metrics service 410 may perform additional calculations or transformations on the data, deriving higher-level metrics from the raw resource usage data. These derived metrics may provide more actionable insights into the performance and efficiency of the software services running in the distributed computing environment 400. The metrics service 410 may store the processed data in a time series database 412, which allows for efficient storage and retrieval of time-based resource usage data.

A data formatting service 414 retrieves data from the time series database 412 and prepares it for further analysis. In some implementations, the data formatting service 414 may normalize this data to create a consistent format for further analysis. The data formatting service 414 may apply additional transformations or aggregations to the data, so that it is in an appropriate format for the subsequent analysis steps.

An analysis service 416 receives the formatted data from the data formatting service 414. The analysis service 416 performs detailed analysis of resource consumption patterns within the distributed computing environment 400. The analysis service 416 may use various analytical techniques to process the formatted data and generate insights. The analysis service 416 may also interface with the configuration parameter service 408, which provides configuration settings that may influence how the analysis is performed. This interaction between the configuration parameter service 408 and the analysis service 416 may be governed by role-based access control (RBAC), so that only authorized users with appropriate permissions can modify analysis configurations. In some cases, the analysis service 416 may employ specific clustering algorithms including k-Nearest Neighbors (kNN), K-means, Birch, Centroid, or DBSCAN/OPTICS to group software services into resource consumption groups based on their usage patterns. The analysis service 416 may also calculate service-level resource consumption profiles for the software services based on the node-level resource usage data, potentially normalizing this data based on a configurable resource consumption hierarchy.

An optimization service 418 works in conjunction with the analysis service 416 to identify opportunities for improving resource allocation and utilization within the distributed computing environment 400. The optimization service 418 may act as a resource optimization advisor, providing recommendations on resource allocation based on the insights generated by the analysis service 416. In some cases, the optimization service 418 may suggest changing (e.g., increasing or decreasing) computing resource allocations to impacted services or recommend modifications to the source code of services to improve their resource efficiency.

An application categorizer service 420 may also interact with the analysis service 416. The application categorizer service 420 may classify software services based on their resource consumption patterns, functionality, or other characteristics. This categorization may help in identifying similar services for comparison or in applying optimization strategies that are tailored to specific types of applications. The application categorizer service 420 may also analyze application sensitivity to restarts and connectivity issues, providing insights that can inform strategies for improving service resilience.

A data store 422 interacts with the optimization service 418 and the application categorizer service 420. The data store 422 may store historical data, optimization recommendations, application categorizations, and other relevant information that can be used to inform future analysis and decision-making processes. This persistent storage may allow the system to learn from past observations and continuously refine its optimization strategies.

A data visualization service 424 retrieves data from the data store 422 and generates visual representations of resource usage patterns, optimization recommendations, and other relevant insights. These visualizations may be presented through a user interface 426, allowing users to interact with and explore the data. The system may also include a language model for processing natural language queries about resource usage, enabling users to ask questions and receive insights in a more intuitive manner.

A network visualization service 428 works alongside the data visualization service 424 to provide specific visualizations related to network usage and communication patterns within the distributed computing environment 400. These visualizations may be presented through the user interface 426. Doing so may help in visually identifying bottlenecks or inefficiencies in inter-service communication.

An alerts service 430 monitors the analyzed data (from the analysis service 416) and generates notifications when certain conditions or thresholds are met. For example, the alerts service 430 may notify administrators when a service is consuming an unusually high amount of resources or when the system identifies an opportunity for resource optimization. The alerts service 430 may also identify patterns in resource usage related to external events like conferences, enabling proactive resource management. The interaction between the analysis service 416 and the alerts service 430 may be governed by role-based access control (RBAC), so that only authorized users with appropriate permissions can receive alerts.

In some cases, the distributed computing environment 400 further includes an auto scaler service (not separately illustrated) that uses the insights generated by the analysis service 416 and optimization service 418 to automatically adjust resource allocations. This auto scaler service may use historical data and identified patterns to anticipate future resource needs and proactively scale services up or down accordingly. By leveraging these predictive capabilities, the distributed computing environment 400 may be updated based on past and/or predicted future resource consumption, promoting efficient resource utilization as demands change over time.

In some implementations, the distributed computing environment may incorporate business-oriented features to enhance its utility and economic impact. The system may analyze resource consumption patterns in relation to business metrics, such as operating costs or power consumption. This analysis may inform decision-making processes regarding resource allocation, helping to align technical optimizations with business objectives. The system may generate reports that translate technical metrics into financial terms, providing stakeholders with insights into the economic implications of resource usage patterns.

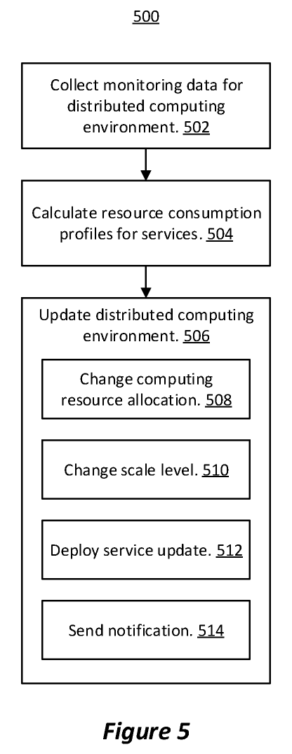

FIG. 5 illustrates a flowchart of a method 500 for adapting resource consumption in a distributed computing environment, according to some implementations. The method 500 will be described in conjunction with the distributed computing environment 200 of FIG. 2. The method 500 may be performed to improve resource utilization within the distributed computing environment 200. For example, at least some steps may be performed by the management server 204 (e.g., the management service 208 running thereon).

In step 502, the management server 204 collects monitoring data for the distributed computing environment 200. The distributed computing environment 200 comprises a plurality of compute nodes 202 running a plurality of software services 206. The monitoring data comprises node-level resource usage data for the software services 206. The node-level resource usage data may be collected using a resource collection agent 210 running in each of the compute nodes 202. In some cases, the resource collection agent 210 may use extended Berkeley Packet Filter (eBPF) to efficiently collect the node-level resource usage data without significantly impacting the performance of the monitored software services 206.

The node-level resource usage data may comprise per-container CPU utilization, memory usage, I/O operations, network bandwidth consumption, network latency, inter-container communication metrics, system call patterns, programming language-specific metrics, and database query patterns. In some cases, the resource collection agent 210 may also collect data on hardware accelerator usage by the software services 206. Additionally, the resource collection agents 210 may gather information about the programming languages used by the software services 206, such as Java, Python, Go, C++, or Rust, as well as details about the packages and libraries utilized by each service.

In step 504, the management server 204 calculates service-level resource consumption profiles for the software services 206 based on the node-level resource usage data. Calculating the service-level resource consumption profiles may comprise normalizing the node-level resource usage data based on a resource consumption hierarchy.

In step 506, the distributed computing environment 200 is updated based on the service-level resource consumption profiles. In some cases, this may involve identifying an impacted service. The impacted service may be identified based on resource consumption patterns of resource consumption groups. In some cases, the software services 206 may be grouped into resource consumption groups by clustering the service-level resource consumption profiles. The management server 204 may use neural networks in addition to clustering algorithms to perform this grouping and identify the impacted service. These clustering algorithms may include k-Nearest Neighbors (kNN), K-means, Birch, Centroid clustering, or DBSCAN/OPTICS, depending on the nature of the data being analyzed. Updating the distributed computing environment 200 may involve one or more changes, which are detailed in steps 508, 510, 512, and 514.

In step 508, the management server 204 may change (e.g., increase or decrease) a computing resource allocation to an impacted service in the distributed computing environment 200. This change may involve adjusting CPU limits, memory allocations, or other computational resources of the impacted service. The management server 204 may implement these resource allocation changes through a control node, which coordinates resource distribution across the compute nodes 202 in the computing cluster.

In step 510, the management server 204 may change (e.g., increase or decrease) a scale level of the impacted service in the distributed computing environment 200. This may involve adjusting the number of instances of the impacted service in the computing cluster to better match its resource requirements.

In step 512, an update may be deployed to the impacted service by modifying source code of the impacted service. The update may be performed by the management server 204 or by an administrator/developer. In some cases, the management server 204 may recommend changing the programming language or libraries of a service to improve its resource efficiency. The management server 204 may automatically apply recommendations to the distributed computing environment 200, including code-level changes. These code-level changes may address inefficient algorithms, memory leaks, or suboptimal database query patterns identified through the service-level resource consumption profiles. They may also include modifying the software libraries used by the impacted service. In some implementations, the management server 204 may generate pull requests or code change proposals that can be reviewed by developers before implementation.

In step 514, the management server 204 may send a notification regarding recommended updates to the distributed computing environment 200. This notification may be generated by an alerts service and may inform administrators or other relevant parties about changes which should be implemented to improve resource consumption. The notification may include detailed information about the specific resource consumption issues identified, such as services consuming disproportionate amounts of CPU or memory resources, inefficient database query patterns, or opportunities for code-level optimizations. These notifications may be delivered through various channels, including email, SMS, or integration with existing enterprise notification systems, so that the appropriate personnel may be informed of optimization opportunities.

In some implementations, the method 500 may also include predicting future resource consumption for the software services 206 based on the service-level resource consumption profiles. The distributed computing environment 200 may be updated based on this predicted future resource consumption, allowing for proactive resource management.

The management server 204 may perform additional analyses as part of the method 500. For example, the management server 204 may measure power consumption of software service 206, helping to identify opportunities for energy efficiency improvements. The management server 204 may also identify inefficient database access patterns, enabling targeted optimizations of database interactions. These additional analyses may leverage time series data to provide comprehensive insights into resource utilization and performance patterns.

In an example implementation, a method includes: collecting, by a management server, monitoring data for a distributed computing environment, the distributed computing environment including a plurality of compute nodes, the compute nodes running a plurality of software services, where the monitoring data includes node-level resource usage data for the software services, and the node-level resource usage data is collected using a resource collection agent running in each of the compute nodes; calculating, by the management server, service-level resource consumption profiles for the software services based on the node-level resource usage data; and updating the distributed computing environment based on the service-level resource consumption profiles. In some implementations, the method further includes: predicting future resource consumption for the software services based on the service-level resource consumption profiles, where the distributed computing environment is updated based on the predicted future resource consumption. In some implementations, the method further includes: grouping the software services into resource consumption groups by clustering the service-level resource consumption profiles; and identifying an impacted service of the software services based on resource consumption patterns of the resource consumption groups. In some implementations of the method, updating the distributed computing environment includes: changing, by the management server, a computing resource allocation to the impacted service in the distributed computing environment. In some implementations of the method, updating the distributed computing environment includes: changing, by the management server, a scale level of the impacted service in the distributed computing environment. In some implementations of the method, updating the distributed computing environment includes: deploying an update to the impacted service by modifying source code of the impacted service. In some implementations of the method, the node-level resource usage data includes per-container CPU utilization, memory usage, I/O operations, network bandwidth consumption, network latency, inter-container communication metrics, system call patterns, programming language-specific metrics, and database query patterns. In some implementations of the method, calculating the service-level resource consumption profiles includes normalizing the node-level resource usage data based on a resource consumption hierarchy.

In an example implementation, a system includes: a distributed computing environment including a plurality of compute nodes, the compute nodes running a plurality of software services; and a management server configured to: collect node-level resource usage data for the software services using a resource collection agent running in each of the compute nodes; calculate service-level resource consumption profiles for the software services based on the node-level resource usage data; and update the distributed computing environment based on the service-level resource consumption profiles. In some implementations of the system, the management server is further configured to: predict future resource consumption for the software services based on the service-level resource consumption profiles, where the distributed computing environment is updated based on the predicted future resource consumption. In some implementations of the system, the management server is further configured to: group the software services into resource consumption groups by clustering the service-level resource consumption profiles; and identify an impacted service of the software services based on resource consumption patterns of the resource consumption groups. In some implementations of the system, to update the distributed computing environment, the management server is further configured to: change a computing resource allocation to the impacted service in the distributed computing environment. In some implementations of the system, to update the distributed computing environment, the management server is further configured to: change a scale level of the impacted service in the distributed computing environment. In some implementations of the system, to update the distributed computing environment, the management server is further configured to: deploy an update to the impacted service by modifying source code of the impacted service. In some implementations of the system, the node-level resource usage data includes per-container CPU utilization, memory usage, I/O operations, network bandwidth consumption, network latency, inter-container communication metrics, system call patterns, programming language-specific metrics, and database query patterns. In some implementations of the system, to calculate the service-level resource consumption profiles, the management server is further configured to: normalize the node-level resource usage data based on a resource consumption hierarchy.

In an example implementation, a device includes: a processor; and a non-transitory computer-readable medium storing instructions which, when executed by the processor, cause the processor to: collect node-level resource usage data for software services running in compute nodes; calculate service-level resource consumption profiles for the software services based on the node-level resource usage data; group the software services into resource consumption groups by clustering the service-level resource consumption profiles; identify an impacted service of the software services based on resource consumption patterns of the resource consumption groups; and update the impacted service. In some implementations of the device, the node-level resource usage data includes information about software libraries used by the impacted service, and the instruction to update the impacted service includes instructions which further cause the processor to: modify the software libraries used by the impacted service. In some implementations of the device, the instruction to update the impacted service includes instructions which further cause the processor to: change a computing resource allocation to the impacted service. In some implementations of the device, the instruction to update the impacted service includes instructions which further cause the processor to: change a scale level of the impacted service.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A method comprising:
collecting, by a management server, monitoring data for a distributed computing environment, the distributed computing environment comprising a plurality of compute nodes, the compute nodes running a plurality of software services, wherein the monitoring data comprises node-level resource usage data for the software services, and the node-level resource usage data is collected using a resource collection agent running in each of the compute nodes;
calculating, by the management server, service-level resource consumption profiles for the software services based on the node-level resource usage data; and
updating the distributed computing environment based on the service-level resource consumption profiles.

2. The method of claim 1, further comprising:
predicting future resource consumption for the software services based on the service-level resource consumption profiles,
wherein the distributed computing environment is updated based on the predicted future resource consumption.

3. The method of claim 1, further comprising:
grouping the software services into resource consumption groups by clustering the service-level resource consumption profiles; and
identifying an impacted service of the software services based on resource consumption patterns of the resource consumption groups.

4. The method of claim 3, wherein updating the distributed computing environment comprises:
changing, by the management server, a computing resource allocation to the impacted service in the distributed computing environment.

5. The method of claim 3, wherein updating the distributed computing environment comprises:
changing, by the management server, a scale level of the impacted service in the distributed computing environment.

6. The method of claim 3, wherein updating the distributed computing environment comprises:
deploying an update to the impacted service by modifying source code of the impacted service.

7. The method of claim 1, wherein the node-level resource usage data comprises per-container CPU utilization, memory usage, I/O operations, network bandwidth consumption, network latency, inter-container communication metrics, system call patterns, programming language-specific metrics, and database query patterns.

8. The method of claim 1, wherein calculating the service-level resource consumption profiles comprises normalizing the node-level resource usage data based on a resource consumption hierarchy.

9. A system comprising:
a distributed computing environment comprising a plurality of compute nodes, the compute nodes running a plurality of software services; and
a management server configured to:
collect node-level resource usage data for the software services using a resource collection agent running in each of the compute nodes;
calculate service-level resource consumption profiles for the software services based on the node-level resource usage data; and
update the distributed computing environment based on the service-level resource consumption profiles.

10. The system of claim 9, wherein the management server is further configured to:
predict future resource consumption for the software services based on the service-level resource consumption profiles,
wherein the distributed computing environment is updated based on the predicted future resource consumption.

11. The system of claim 9, wherein the management server is further configured to:
group the software services into resource consumption groups by clustering the service-level resource consumption profiles; and
identify an impacted service of the software services based on resource consumption patterns of the resource consumption groups.

12. The system of claim 9, wherein, to update the distributed computing environment, the management server is further configured to:
change a computing resource allocation to the impacted service in the distributed computing environment.

13. The system of claim 9, wherein, to update the distributed computing environment, the management server is further configured to:
change a scale level of the impacted service in the distributed computing environment.

14. The system of claim 9, wherein, to update the distributed computing environment, the management server is further configured to:
deploy an update to the impacted service by modifying source code of the impacted service.

15. The system of claim 9, wherein the node-level resource usage data comprises per-container CPU utilization, memory usage, I/O operations, network bandwidth consumption, network latency, inter-container communication metrics, system call patterns, programming language-specific metrics, and database query patterns.

16. The system of claim 9, wherein, to calculate the service-level resource consumption profiles, the management server is further configured to:
normalize the node-level resource usage data based on a resource consumption hierarchy.

17. A device comprising:
a processor; and
a non-transitory computer-readable medium storing instructions which, when executed by the processor, cause the processor to:
collect node-level resource usage data for software services running in compute nodes;
calculate service-level resource consumption profiles for the software services based on the node-level resource usage data;
group the software services into resource consumption groups by clustering the service-level resource consumption profiles;
identify an impacted service of the software services based on resource consumption patterns of the resource consumption groups; and
update the impacted service.

18. The device of claim 17, wherein the node-level resource usage data comprises information about software libraries used by the impacted service, and the instruction to update the impacted service comprises instructions which further cause the processor to:
modify the software libraries used by the impacted service.

19. The device of claim 17, wherein the instruction to update the impacted service comprises instructions which further cause the processor to:
change a computing resource allocation to the impacted service.

20. The device of claim 17, wherein the instruction to update the impacted service comprises instructions which further cause the processor to:
change a scale level of the impacted service.
